(19) United States
(12) Patent Application Publication
(10) Pub. No.: US 2009/0148273 A1
(43) Pub. Date: Jun. 11, 2009

(54) COMPRESSOR INLET GUIDE VANE FOR TIP TURBINE ENGINE AND CORRESPONDING CONTROL METHOD

(76) Inventors: Gabriel L. Suciu, Glastonbury, CT (US); James W. Norris, Lebanon, CT (US); Craig A. Nordeen, Manchester, CT (US); Brian Merry, Andover, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/719,812

(22) PCT Filed: Dec. 1, 2004
(86) PCT No.: PCT/US04/40207

§ 371 Date: May 21, 2007

(51) Int. Cl. F02C 9/18; F02C 7/057; F01D 17/16

(52) U.S. Cl. 415/159; 415/191; 415/1

(57) ABSTRACT

A tip turbine engine (30) includes a low pressure compressor (22) having a plurality of inlet guide vanes (55) that are mounted at an inlet to the compressor case (50). Each inlet guide vane (55) includes at least one fluid outlet (56) proximate a trailing edge of the inlet guide vane (55), such that fluid flow through the fluid outlet (56) modulates and controls the air flow into the compressor (22). A supply of pressurized fluid may be supplied from compressed air from the compressor (22).

This invention was conceived in performance of U.S. Air Force contract F33657-03-C-2044. The government may have rights in this invention.

### BACKGROUND OF THE INVENTION

The present invention relates to turbine engines, and more particularly to a jet flap inlet guide vane for a compressor for a tip turbine engine.

An aircraft gas turbine engine of the conventional turbofan type generally includes a forward bypass fan, a low pressure compressor, a middle core engine, and an aft low pressure turbine, all located along a common longitudinal axis. A high pressure compressor and a high pressure turbine of the core engine are interconnected by a high spool shaft. The high pressure compressor is rotatably driven to compress air entering the core engine to a relatively high pressure. This high pressure air is then mixed with fuel in a combustor, where it is ignited to form a high energy gas stream. The gas stream flows axially aft to rotatably drive the high pressure turbine, which rotatably drives the high pressure compressor via the high spool shaft. The gas stream leaving the high pressure turbine is expanded through the low pressure turbine, which rotatably drives the bypass fan and low pressure compressor via a low pressure shaft.

Some conventional gas turbine engines use mechanically activated, pivotably mounted inlet guide vanes at the compressor inlet to change the compressor airflow. However, these mechanically activated inlet guide vanes are heavy and costly. One conventiorial gas turbine engine includes a plurality of fixedly mounted inlet guide vanes, each including a plurality of holes adjacent a trailing edge. Compressed air taken from the compressor is fed to the inlet guide vanes and flows through the holes. The air through the holes in the inlet guide vanes redirects the inlet air flow without physically moving the inlet guide vanes. Controlling the amount of air supplied to the inlet guide vanes modulates and controls the inlet air flow.

Although highly efficient, conventional gas turbine engines operate in an axial flow relationship. The axial flow relationship results in a relatively complicated elongated engine structure of considerable length relative to the engine diameter. This elongated shape may complicate or prevent packaging of the engine into particular applications.

A recent development in gas turbine engines is the tip turbine engine. Tip turbine engines may include a low pressure axial compressor directing core airflow into hollow fan blades. The hollow fan blades operate as a centrifugal compressor when rotating. Compressed core airflow from the hollow fan blades is mixed with fuel in an annular combustor, where it is ignited to form a high energy gas stream which drives the turbine that is integrated onto the tips of the hollow bypass fan blades for rotation therewith as generally disclosed in U.S. Patent Application Publication Nos.: 20030192303; 20030192304; and 20040025490. The tip turbine engine provides a thrust-to-weight ratio equivalent to or greater than conventional turbofan engines of the same class, but within a package of significantly shorter length.

### SUMMARY OF THE INVENTION

A tip turbine engine includes a low pressure compressor having a plurality of inlet guide vanes that are mounted at an inlet to the compressor case. Each inlet guide vane includes at least one fluid outlet. Pressurized fluid through the at least one fluid outlet modulates and controls the flow of air into the compressor, without physically moving the inlet guide vanes. Thus, the inlet guide vanes are lighter weight and require fewer parts than the previously known methods. The supply of pressurized fluid may be supplied from compressed core air flow from the compressor. The low pressure compressor is mounted radially inward of the bypass air flow path.

Because the compressor in a tip turbine engine is radially inward of a bypass air flow path, space in and around the compressor case is lrnited. The inlet guide vane of the present invention is simple, compact and lightweight and can be mounted within the compressor case of a tip turbine engine.

### BRIEF DESCRIPTION OF THE DRAWINGS

Other advantages of the present invention can be understood by reference to the following detailed description when considered in connection with the accompanying drawings wherein:

FIG. 1 is a partial sectional perspective view of a tip turbine engine.

FIG. 2 is a longitudinal sectional view of the tip turbine engine of FIG. 1 along an engine centerline.

FIG. 3 is an enlarged top perspective sectional view of the compressor inlet guide vane of FIG. 2.

### DETAILED DESCRIPTION OF THE PREFERRED EMBODIMENTS

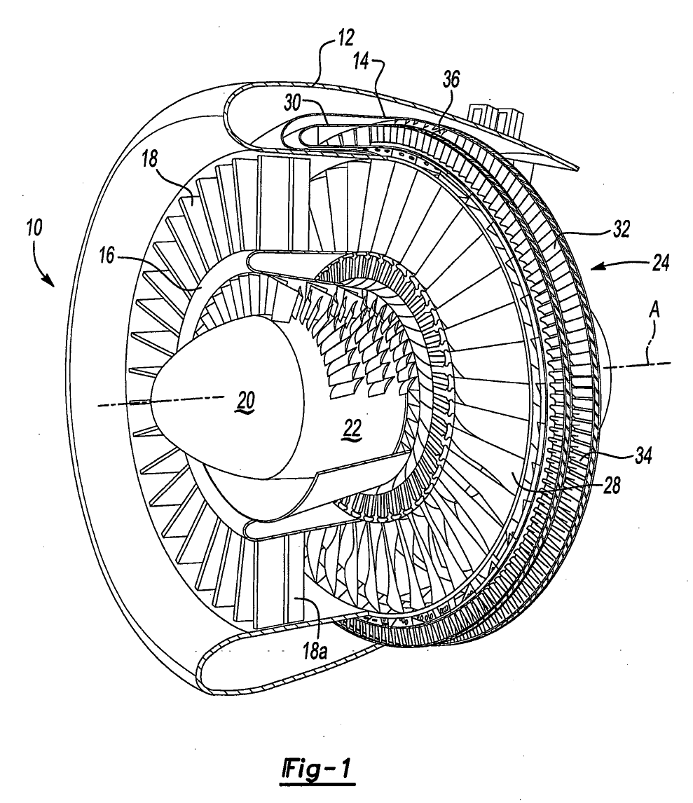

FIG. 1 illustrates a general perspective partial sectional view of a tip turbine engine (TTE) type gas turbine engine 10. The engine 10 includes an outer nacelle 12, a rotationally fixed static outer support structure 14 and a rotationally fixed static inner support structure 16. A plurality of fan inlet guide vanes 18 are mounted between the static outer support structure 14 and the static inner support structure 16. Each inlet guide vane preferably includes a variable trailing edge 18A.

A nosecone 20 is preferably located along the engine centerline A to improve airflow into an axial compressor 22, which is mounted about the engine centerline A behind the nosecone 20.

A fan-turbine rotor assembly 24 is mounted for rotation about the engine centerline A aft of the axial compressor 22. The fan-turbine rotor assembly 24 includes a plurality of hollow fan blades 28 to provide internal, centrifugal compression of the compressed airflow from the axial compressor 22 for distribution to an annular combustor 30 located within the rotationally fixed static outer support structure 14.

A turbine 32 includes a plurality of tip turbine blades 34 (two stages shown) which rotatably drive the hollow fan blades 28 relative a plurality of tip turbine stators 36 which extend radially inwardly from the rotationally fixed static outer support structure 14. The annular combustor 30 is disposed axially forward of the turbine 32 and communicates with the turbine 32.

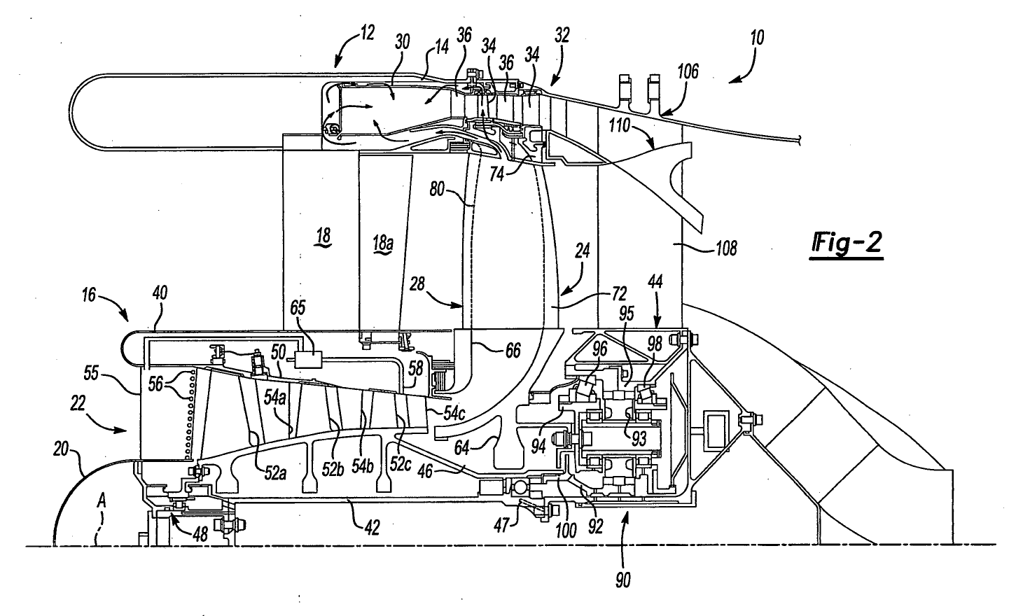

Referring to FIG. 2, the rotationally fixed static inner support structure 16 includes a splitter 40, a static inner support housing 42 and a static outer support housing 44 located coaxial to said engine centerline A.

The axial compressor 22 includes the axial compressor rotor 46, which is mounted for rotation upon the static inner support housing 42 through an aft bearing assembly 47 and a forward bearing assembly 48. A plurality of compressor blades 52a-c extend radially outwardly from the axial compressor rotor 46. A fixed compressor case 50 is mounted within the splitter 40. A plurality of compressor vanes 54a-c extend radially inwardly from the compressor case 50 between stages of the compressor blades 52a-c. The compressor blades 52a-c and compressor vanes 54a-c are arranged circumferentially about the axial compressor rotor 46 in stages (three stages of compressor blades 52a-c and compressor vanes 54a-c are shown in this example).

A plurality of compressor inlet guide vanes (IGVs) 55 are disposed upstream of the compressor blades 52a-c and compressor vanes 54a-c. A plurality of openings or nozzles 56 are formed near the trailing edge of the guide vanes 55. The nozzles 56 are directed in a direction at approximately 45 degrees relative to the surface of the compressor IGV 55.

Some compressed air is supplied from the axial compressor 22 via conduit 58 to an optional jet valve 65, which sends a controlled amount of the core air flow to the inlet guide vanes 55. The jet valve 65 may adjust the amount of air flowing toward the inlet guide vanes 55 and may release excess air into the cavity between the compressor case 50 and the splitter 40, where it may pass through the inlet guide vane 18 and discharge at an outer diameter of the nacelle 12.

The fan-turbine rotor assembly 24 includes a fan hub 64 that supports a plurality of the hollow fan blades 28. Each fan blade 28 includes an inducer section 66, a hollow fan blade section 72 and a diffuser section 74. The inducer section 66 receives airflow from the axial compressor 22 generally parallel to the engine centerline A and turns the airflow from an axial airflow direction toward a radial airflow direction. The airflow is radially communicated through a core airflow passage 80 within the fan blade section 72 where the airflow is centrifugally compressed. From the core airflow passage 80, the airflow is diffused and turned once again by the diffuser section 74 toward an axial airflow direction toward the annular combustor 30. Preferably, the airflow is diffused axially forward in the engine 10; however, the airflow may alternatively be communicated in another direction.

The tip turbine engine 10 may optionally include a gearbox assembly 90 aft of the fan-turbine rotor assembly 24, such that the fan-turbine rotor assembly 24 rotatably drives the axial compressor rotor 46 via the gearbox assembly 90. In the embodiment shown, the gearbox assembly 90 provides a speed increase at a 3.34-to-one ratio. The gearbox assembly 90 may be an epicyclic gearbox, such as a planetary gearbox as shown, that is mounted for rotation between the static inner support housing 42 and the static outer support housing 44. The gearbox assembly 90 includes a sun gear 92, which rotates the axial compressor rotor 46, and a planet carrier 94, which rotates with the fan-turbine rotor assembly 24. A plurality of planet gears 93 each engages the sun gear 92 and a rotationally fixed ring gear 95. The planet gears 93 are mounted to the planet carrier 94. The gearbox assembly 90 is mounted for rotation between the sun gear 92 and the static outer support housing 44 through a gearbox forward bearing 96 and a gearbox rear bearing 98. The gearbox assembly 90 may alternatively, or additionally, reverse the direction of rotation and/or may provide a decrease in rotation speed.

A plurality of exit guide vanes 108 are located between the static outer support housing 44 and the rotationally fixed exhaust case 106 to guide the combined airflow out of the engine 10 and provide forward thrust. An exhaust mixer 110 mixes the airflow from the turbine blades 34 with the bypass airflow through the fan blades 28.

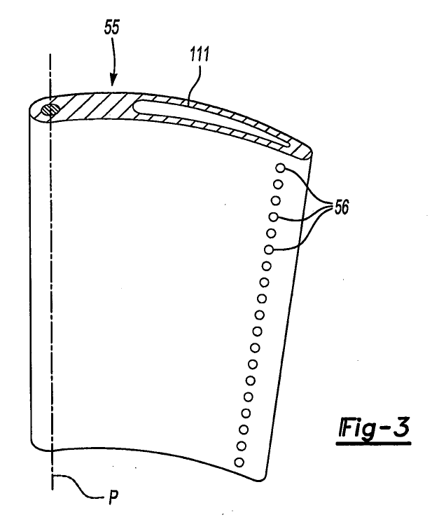

FIG. 3 illustrates one of the compressor IGVs 55 in more detail. The compressor IGV 55 includes an elongated interior chamber 111 in fluid communication with the nozzles 56. Alternatively, conduit or other passageways could be defined within the compressor IGV 55. Although the nozzles 56 are shown aligned proximate a trailing edge of the IGV 55, other locations and configurations could be utilized.

In operation, core airflow enters the axial compressor 22, where it is compressed by the compressor blades 52. As determined by the jet valve 65, some of the core air flow is sent to the interior chambers 111 of the compressor IGVs 55. This pressurized air then exits the nozzles 56 of the compressor IGVs 55, thereby modulating and controlling the flow of air into the axial compressor 22. The jet flap compressor IGVs 55 improve the stability of the tip turbine engine 10, while providing a simply, lightweight, inexpensive means for providing such control.

The compressed air from the axial compressor 22 that is not sent to the IGVs 55 enters the inducer section 66 in a direction generally parallel to the engine centerline A, and is then turned by the inducer section 66 radially outwardly through the core airflow passage 80 of the hollow fan blades 28. The airflow is further compressed centrifugally in the hollow fan blades 28 by rotation of the hollow fan blades 28. From the core airflow passage 80, the airflow is turned and diffused axially forward in the engine 10 into the annular combustor 30. The compressed core airflow from the hollow fan blades 28 is mixed with fuel in the annular combustor 30 and ignited to form a high-energy gas stream.

The high-energy gas stream is expanded over the plurality of tip turbine blades 34 mounted about the outer periphery of the fan-turbine rotor assembly 24 to drive the fan-turbine rotor assembly 24, which in turn rotatably drives the axial compressor 22 either directly or via the optional gearbox assembly 90. The fan-turbine rotor assembly 24 discharges fan bypass air axially aft to merge with the core airflow from the turbine 32 in the exhaust case 106.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A turbine engine comprising:
a fan having a plurality of fan blades generating a fan exhaust flowing through a fan exhaust air flow path through the turbine engine;
a compressor having a plurality of radially extending compressor blades disposed radially inward of the fan exhaust air flow path; and
a compressor inlet guide vane (IGV) mounted upstream of the plurality of compressor blades, the IGV including a fluid outlet, the fluid outlet positioned on the IGV such that fluid flow through the fluid outlet redirects air flow into the compressor.

2. The turbine engine of claim 1 further including a valve having an inlet leading from an area aft of the compressor blades to selectively direct air to the IGV.

3. The turbine engine of claim 2 further including a plurality of stages of the compressor blades and a plurality of stages of compressor vanes, wherein the inlet is located between one of the stages of compressor blades and one of the stages of compressor vanes.

4. The turbine engine of claim 1 wherein at least one of the fan blades defines a compressor chamber extending radially therein, the compressor blades compressing core airflow that is sent to the compressor chamber.

5. The turbine engine of claim 1 further including a jet valve controllably adjusting a flow of fluid to the IGV.

6. The turbine engine of claim I wherein the fluid outlet is one of a plurality of nozzles.

7. The turbine engine of claim 1 wherein the fluid outlet is located near a trailing edge of the IGV.

8. The turbine engine of claim 7 wherein the fluid outlet is directed substantially normal to a surface of the IGV through which the fluid outlet extends.

9. A compressor for a turbine engine comprising:
a compressor case extending axially between an inlet and an outlet, the outlet adapted to provide a fluid connection to an inducer section of a fan rotor assembly;
a plurality of radially extending compressor blades disposed within the compressor case and rotatable about an axis; and
a compressor inlet guide vane (IGV) mounted between the inlet to the compressor case and the plurality of compressor blades, the IGV including a fluid outlet, the fluid outlet positioned on the IGV such that fluid flow through the fluid outlet redirects air flowing to the plurality of compressor blades.

10. The compressor of claim 9 further including a valve having an inlet leading from an area between the IGV and the outlet to selectively direct air to the IGV.

11. The compressor of claim 10 further including a plurality of stages of the compressor blades and a plurality of stages of compressor vanes, wherein the inlet is located between one of the stages of compressor blades and one of the stages of compressor vanes.

12. The compressor of claim 9 further including a jet valve controllably adjusting a flow of fluid to the IGV.

13. The compressor of claim 9 wherein the fluid outlet is a plurality of nozzles.

14. The compressor of claim 9 wherein the fluid outlet is located near a trailing edge of the IGV.

15. The compressor of claim 14 wherein the fluid outlet is directed substantially normal to a surface of the IGV through which the fluid outlet extends.

16. A method for controlling an inlet guide vane of a compressor in a tip turbine engine, the inlet guide vane extending transversely to a core airflow path through the compressor, the method including the steps of:
supplying a pressurized fluid to the inlet guide vane; and
controlling a flow of the fluid from a fluid outlet on the inlet guide vane to selectively redirect airflow past the inlet guide vane.

17. The method of claim 16 wherein the pressurized fluid in said step a) is air from the compressor.

18. The method of claim 16 wherein the compressor is located radially inward of a bypass air flow path.

19. The method of claim 16 further including the step of adjusting the flow of the fluid in said step b) in order to change an amount of compressed air provided by the compressor to compressor chambers within each of a plurality of hollow fan blades.

20. The method of claim 16 wherein the fluid outlet is disposed proximate a trailing edge of the inlet guide vane.
